(19) United States
(12) Patent Application Publication
(10) Pub. No.: US 2026/0093233 A1
(43) Pub. Date: Apr. 2, 2026

(54) COMPUTER-IMPLEMENTED METHOD FOR PROCESSING MACHINE-RELATED DATA OF A COMPONENT OF A DEVICE

(71) Applicant: Qlar Europe GmbH, Darmstadt (DE)

(72) Inventor: Viktor RAIS, Darmstadt (DE)

(73) Assignee: Qlar Europe GmbH, Darmstadt (DE)

(21) Appl. No.: 19/410,391

(22) Filed: Dec. 5, 2025

Related U.S. Application Data
(63) Continuation of application No. PCT/EP2024/065143, filed on Jun. 3, 2024.

(30) Foreign Application Priority Data
Jun. 5, 2023 (DE) 10 2023 114 652.1

(51) Int. Cl. G05B 19/05

(52) U.S. Cl. CPC G05B 19/058; G05B 19/054

(57) ABSTRACT

A computer-implemented method for processing machine-related data in order to obtain at least one trained machine-learning model and to a computer-implemented method for detecting the operating state of a component of a device. Provided is also a device for processing data, and designed to carry out a respective method of the computer-implemented methods or both computer-implemented methods, and to a data structure.

This nonprovisional application is a continuation of International Application No. PCT/EP2024/065143, which was filed on Jun. 3, 2024, and which claims priority to German Patent Application No. 10 2023 114 652.1, which was filed in Germany on Jun. 5, 2023, and which are both herein incorporated by reference.

### BACKGROUND OF THE INVENTION

### Field of the Invention

The present invention relates to a computer-implemented method for processing machine-related data in order to obtain at least one trained machine-learning model and to a computer-implemented method for detecting an operating state of a component of a device. The present invention also relates to a device for processing data, comprising means which are designed to carry out a respective method of the computer-implemented methods or both computer-implemented methods, and to a data structure.

### Description of the Background Art

Computer-implemented methods for detecting operating states of a device are known from the prior art. For this purpose, data recorded during the operation of the device, for example by means of sensors for various measured variables, can be evaluated. For example, by detecting patterns in the data that have been associated with a particular operating state of the device in the past, a statement can be made about its current operating state. Even though such an approach has led to useful results in the past, it is still desirable to further improve the reliability and efficiency with which operating states of a device can be detected and to further reduce the effort required to implement the measures necessary for detection.

### SUMMARY OF THE INVENTION

It is therefore an object of the present invention to overcome the described disadvantages of the prior art and in particular to provide means by which operating states of a device can be detected more reliably, efficiently and with less effort.

The object is achieved, in an example, by the invention according to a first aspect in that a computer-implemented method for processing machine-related data, which in particular represent information on state variables and events associated with or assignable to device components or can be used to determine same, in order to obtain at least one trained machine-learning (ML) model, the computer-implemented method comprising: that (i) components of at least two devices are selected as specific components and are each assigned to at least one of at least one definitional component group and/or (ii) for each device of at least two devices, at least one component of the respective device is selected as a specific component and is assigned to at least one and/or exactly one component group of at least one definitional component group in such a way that after the assignment of all specific components of all devices (a) the specific components assigned to one and the same component group are all similar or identical and/or (b) the specific components which are all similar or identical among all specific components of all devices are each assigned to the same component group, that data are received which, in relation to each of the specific components, represent and/or make it possible to determine information on (i) one or more of the state variables assigned or assignable to the respective specific component and (ii) one or more events relating to the respective specific component; and that for each of the at least one component groups, a separate ML model is trained on a separate database, each of which is at least partially created on the basis of at least parts of the received data.

The invention is therefore based on the surprising finding that with cross-device information on corresponding device components, a database can be created on which an ML model for detecting operating states of components of the respective component group can be trained in a particularly advantageous manner.

In other words, several devices are definitionally subdivided into their components, and for similar or identical components, the component-specific information is compiled in groups. This makes it possible to advantageously obtain training data for training an ML model directed to a particular component type and to carry out the training of the correspondingly specialized ML model.

With the proposed computer-implemented method, the database can also be based on data of corresponding components, especially from different devices. As a result, the database inherently contains information on a plurality of circumstances from different application scenarios of the respective component type. This enables particularly high reliability in the detection of operating states when the ML model trained on the database is subsequently used, partly even under previously unknown operating states.

Therefore, an ML model trained in this way can subsequently be used very advantageously to detect in a particularly accurate and reliable manner the operating state of a corresponding, i.e., similar or identical, component in a device. Data on this component do not necessarily have to have been, but advantageously may be, part of the database on which the ML model was trained.

Unlike conventional computer-implemented methods, according to the proposed computer-implemented method, the device is no longer considered as a whole and no longer only data relating to the entire device are included. Instead, the similar or identical components of several devices are also or exclusively considered and a database is created for each of them, which in turn forms the basis for training an ML model directed to the corresponding component group.

The data with information on state variables can then be used at least partially as input data during training and/or the data with information on events can then be used at least partially as truth data during training.

The events can represent operating states and, for example, have been manually marked with reference to state variables.

Using the individual ML models, operating states for the individual components can then be detected based on input data for corresponding state variables and, based thereon, an operating state of the device can also be detected as a result.

An advantageous approach against the background of the proposed computer-implemented method can therefore be as follows:
Several devices are selected.
Each of these devices is (definitionally) subdivided into several components. For each device, several of these components are selected (which are then referred to as the specific components).
All specific components of all devices are then (definitionally) grouped in such a way that the components which are all similar or identical among the specific components are always assigned to a common component group (X).
For each component within a component group (X), the data of the individual components (i.e., data representing information on previously defined state variables and on detected events of the individual components) are merged into a common database, so that a separate database is available for each component group (X). For example, each database can contain input data and truth data with which an ML model can be trained.
On each database obtained in this way, an individual ML model is trained for each component group (X).
A model trained in this way on a database for a component group (X) can then be used to detect operating states for components that are similar or identical to the components of the component group (X).

It shall be appreciated that assigning a specific component to a component group is a purely definitional process. Likewise, a component group itself is a purely definitional measure. In this respect, group assignment (i.e., the assignment of a specific component to a component group) is carried out for the purpose of appropriately merging the information of the individual components, i.e., in particular, for the purpose of merging the information of the individual components into a common database according to their group association. Hence, the components of a component group are usually not, and do not have to be, actually (i.e., physically) grouped within the scope of the proposed computer-implemented method.

In the proposed computer-implemented method, each specific component is advantageously assigned separately to a component group. Even if several specific components have been selected for a device, assignment to a component group is advantageously carried out individually for each specific component. Thus, if N specific components have been selected for a particular device, said N specific components can be assigned to 1 to N different component groups. For example, a device may have several similar or identical components, so that two or more than two specific components of said device are assigned to one and the same component group.

At least the information on some of the state variables and/or events can, for example, be represented and/or determined by partial data of the received data, preferably exclusively.

Each database on which a separate ML model is trained for a component group can, for example, be created from data that represent information on the state variables and/or events of such components or that make it possible to determine which components are assigned to the respective component group.

For example, the received data may be received from a remote computing device, from a data network, from a data carrier, via a data connection, and/or from a sensor.

The processed machine-related data therefore represent, at least in part, information on state variables and events assigned or assignable to device components or can be used to determine them.

In the present application, the term “ML model” is used as an abbreviation for “machine-learning (data) model”. Such an ML model can, for example, be a convolutional neural network (CNN), in particular from the field of deep learning.

For the purposes of the present application, two components are preferably similar if (i) they each perform the same function in the respective devices, (ii) they are each used for corresponding purposes in the respective devices and/or (iii) they are of identical construction.

Alternatively or additionally, it can also be provided that for each device of at least two devices, at least one component of the respective device is selected as a specific component and is assigned to at least one and/or exactly one component group of at least one definitional component group in such a way that after the assignment of all specific components of all devices (i) the specific components assigned to one and the same component group are all similar or identical and/or (ii) the specific components which are all similar or identical among all specific components of all devices are each assigned to the same component group.

So, for each device, at least one component is selected as a specific component. And each specific component is assigned to at least one component group. After all specific components have been assigned, the boundary condition (i) and/or (ii) must be fulfilled. By organizing the assignments accordingly, a database can be obtained in a particularly reliable manner on which an ML model can be trained that is tailored to components of the respective component group.

Alternatively or additionally, it can also be provided for at least two, preferably all, of the at least two devices to be of different types.

This has proven to be particularly advantageous because it allows information from different application scenarios resulting from the different device types to be included in the database.

For example, a component X can be provided in a corresponding manner in two devices (U, V) that are completely different in terms of their intended use, i.e., a component X in device U, and a component X in device V. The data relating to component X in device U and the data relating to component X in device V then form a common database (if necessary with further data of component X or similar or identical components). An ML model trained on this database can also be used to detect states of component X (or a similar component) provided in a device W (which may be different from devices U and V).

However, the proposed computer-implemented method of course also allows components to be provided in consistently identical or at least partially identical devices.

Alternatively or additionally, it can also be provided for at least two of the at least two devices to be selected differently from the group of devices comprising: dosing device, screening device, vibration device, mill, extruder, conveying device, weighing device, mixing device and/or test bench.

These different types of devices are particularly advantageous.

In an example, all of the at least two devices can be used in the field of bulk material handling, bulk material treatment and/or bulk material processing.

Alternatively or additionally, it can also be provided for each selected specific component to be assigned to at least one and/or exactly one component group of at least two definitional component groups.

The definitional component groups are advantageously all different.

As a result, at least two databases can be created and at least two ML models (one per database) are trained.

Alternatively or additionally, it can also be provided for at least one component group to be selected from the group of component groups comprising: wheel, axle, bogie, carriage, gearbox, bearing (machine element), guide element, motor, discharge element, drive system, conveyor belt, agitator, weighing unit and/or unbalance drive.

A discharge element can be, for example, a screw conveyor, a spiral and/or a slide gate.

A weighing unit can be, for example, a weighing eye, a weighing disk and/or a weighing beam.

Preferably, at least two or all definitional component groups are selected from the mentioned group of component groups.

Alternatively or additionally, it can also be provided for two or more than two specific components to be selected for each device of the at least two devices and/or for the respectively selected specific components to be assigned to different component groups for each device of the at least two devices.

By selecting several components per device, the resulting ML models can be used to perform particularly comprehensive monitoring of device components.

By assigning the components to different component groups, it is more reliably ensured that the databases of the individual component groups are created from information of as many devices as possible.

Alternatively or additionally, it can also be provided for the specific components to be mechanical components, electrical components and/or components of the devices that are subject to wear.

Preferably, this applies to all specific components.

Alternatively or additionally, it can also be provided for each of the at least one component group to be assigned at least one and/or exactly one specific component of each of the at least two devices.

This makes it possible to more reliably ensure that the databases of the respective component groups are created from information of as many devices as possible.

Alternatively or additionally, it can also be provided for each specific component to be assigned to exactly one component group or for at least one of the specific components to be assigned to several component groups.

Alternatively or additionally, it can also be provided for the received data to represent or make it possible to determine information on state variables and/or events, in particular error events and/or good events, in relation to the specific components, wherein the received data preferably include individual information for at least one and/or each specific component.

Advantageously, the individual information represents information on component-specific state variables and/or events.

The received data can advantageously comprise several partial data, and the information on each state variable of each component and the information on each event of each component is each contained in separate partial data. In one embodiment, the partial data may at least partially overlap and/or the partial data may be at least partially combined per component (for example, into data representing information of the respective component and/or into data representing events of the respective component).

Alternatively or additionally, it can also be provided for the received data to be at least partially raw data from sensors or data derived therefrom, and preferably for at least some of the sensors to be arranged on the specific components, and/or for the received data to originate at least partially from a PLC system.

Sensor data can be recorded efficiently using appropriate sensors and are therefore particularly suitable for creating a database.

The received data can be at least partially preprocessed sensor data, which preferably originate at least partially from sensors arranged on the respective specific components.

Alternatively or additionally, it can also be provided for the respective database for training the respective ML model of a component group to contain, in particular explicitly and/or implicitly, at least the information on state variables and/or events in relation to the specific components assigned to the respective component group.

As a result, each database (of a component group) is formed by at least those data that at least partially represent or make it possible to determine information on the state variables and/or events of the specific components assigned to the respective component group. Particularly advantageously, this makes it possible to obtain a group-specific database and thus to carry out targeted training of an ML model per component group.

Alternatively or additionally, it can also be provided for the information on each state variable to (i) be represented by time series data, (ii) have a time-dependent course (iii) be represented or determinable by at least part of the received data and/or (iv) be obtained by processing at least part of the received data and/or for (i) each state variable to be assigned to exactly one and/or at least one specific component, (ii) several specific components to be assigned corresponding state variables and/or (iii) the same state variables to be assigned to each specific component within a component group.

For example, the received data are time series data (e.g., time-indexed sensor data).

Identical state variables can be considered for the specific components assigned to a common component group.

For at least one, preferably for each, specific component, the state variables can be at least partially selected from the group of state variables comprising: direction of movement (for example in connection with the data of a vibration sensor), speed (for example in connection with the data of a speed sensor), torque (for example in connection with the data of a torque sensor), electrical voltage, such as an input voltage (for example in connection with the data of a voltage sensor) and/or electrical current (for example in connection with the data of a current sensor).

Alternatively or additionally, it can also be provided for the state variables of at least one and/or all specific components to be selected, in particular manually and/or with a feature selection algorithm, from a selection of state variables, wherein selection of the state variables for the specific components of a component group is preferably carried out jointly.

For example, data can be continuously provided and/or received for different state variables; however, only the data from state variables selected as described above are then actually used to create a database.

Selection of the state variables for the specific components can be checked repeatedly and adjusted depending on a result of the check. This allows new state variables to be taken into account, which become more meaningful over time.

Alternatively or additionally, it can also be provided for each event of a specific component to be an assignment of a good or bad marking to an event time or an event period in relation to the course of one or more state variables, assigned in particular to the respective specific component, in particular by assigning a state category to the respective time or period.

Advantageously, as a result, the value (at the time) or the course (during the period) of one or more state variables relevant to the event (or in this case the data underlying such state variable) can be directly determined based on an event (via the assignment linked to it).

Alternatively or additionally, it can also be provided for the processing of the machine-related data to be carried out in order to obtain at least one trained ML model and/or for at least one trained ML model to be obtained as a result of the processing of the data, in particular at least such ML model which is calculated to detect an operating state in a particular component of a device in a computer-implemented method according to the second aspect of the invention.

The proposed computer-implemented method for processing machine-related data is therefore advantageously a computer-implemented method for obtaining at least one trained ML model.

Alternatively or additionally, it can also be provided for the individual ML model trained in relation to a particular component group to be usable for detecting operating states, in particular error states, in relation to a component used in a device which is similar or identical to the specific components that are assigned or assignable to the particular component group, by calculating the respective ML model on a database which is obtained at least partially from data which represent and/or make it possible to determine information on one or more state variables assigned or assignable to the component used, which correspond to the state variables considered during the training of the respective ML model.

The trained ML model can therefore be calculated based on data from live operation of a device or its components, which data correspond to the data from the training, and can thus detect operating states of components of the device.

The object is achieved by the invention according to a second aspect in that a computer-implemented method is proposed for detecting an operating state, in particular an error state, in a particular component of a device, the computer-implemented method comprising that data, which represent and/or make it possible to determine information on one or more state variables assigned or assignable to the particular component, are received and that an ML model, which was trained during a computer-implemented method according to the first aspect of the invention preceding the detection, is calculated at least partially with the received data as input data, wherein preferably the particular component is assignable to the component group for which the ML model was trained in the preceding computer-implemented method and/or the database used in the preceding training of the ML model was created at least partially with data which represent and/or make it possible to determine information on state variables that correspond to the one or more state variables assigned or assignable to the particular component.

Hence, by means of an ML model trained according to a computer-implemented method according to the first aspect of the invention, the operating state of a device component, and thus advantageously also of a device as a whole, can be detected by supplying the ML model with data corresponding to the data used during training (i.e., the model is calculated based on such data).

Accordingly, if, during training of the ML model, data concerning information on the state variables X and Y have at least partially formed the database, then current operating states of the respective device component can be detected by means of the trained ML model on the basis of current data concerning information on the very state variables X and Y for a device component to be monitored.

Due to the specifically designed prior training, the trained data model is particularly well suited to reliably and precisely detect operating states of device components.

In this respect, all advantages explained in relation to the computer-implemented method according to the first aspect of the invention apply accordingly to the computer-implemented method according to the second aspect of the invention. Therefore, reference can be made to the previous statements at this point.

Alternatively or additionally, it can also be provided that, for calculating the trained ML model, the ML model of the ML models trained within the scope of the method according to the first aspect of the invention should be used which was trained on data from specific components which are assigned or assignable to specific components of the component group to which the particular component is also assigned or assignable.

By selecting the ML model so that it has been trained on data from components that belong to the same component group as the particular component, a particularly reliable detection of the operating state of the particular component can be achieved.

Alternatively or additionally, it can also be provided for an operating state of the particular component to be detected at least partially based on a result of the calculation of the trained ML model and/or for a control signal to be generated in response to the detection of the operating state of the particular component and/or as a function of the detected operating state of the particular component.

The calculation makes it possible to detect the operating state of the particular component particularly reliably. The control signal can be used, for example, to communicate information relating to the detected operating state of the particular component to an entity which may also be different from the particular component and/or from the device comprising the particular component. This can cause the entity to perform an action in response to the control signal. For example, the control signal can represent or make it possible to determine the detected operating state of the particular component.

In one embodiment, the control signal is generated by a control signal generation unit. The control signal generation unit can be implemented in software, in hardware, or in a combination of both.

Alternatively or additionally, it can also be provided for the particular component and/or the device comprising the particular component to be influenced by the control signal, wherein such influencing preferably comprises adapting a configuration of the component and/or device, adapting an energy consumption of the component and/or device and/or switching off the particular component and/or device.

For example, such influencing can prevent an error state of the particular component and/or the higher-level device (e.g., before it occurs) and/or can eliminate an error state of the particular component and/or the higher-level device (e.g., if it has already occurred).

Advantageously, resource-efficient operation of the particular component and/or the higher-level device can also be enabled or improved by such influencing. For example, in an operating state representing inactivity of the particular component, another component of the same and/or of another device can be activated and/or yet another component of the same and/or of another device can be deactivated.

Adjusting a configuration can, for example, include adjusting one or more parameters of the particular component and/or higher-level device. In this way, for example, a mode of operation of the particular component and/or the higher-level device can be achieved, such as the above-described prevention and/or elimination of an error state.

Adjusting an energy consumption can, for example, include activating and/or deactivating functions of the particular component and/or higher-level device.

Alternatively or additionally, it can also be provided for the received data, which represent and/or make it possible to determine information on one or more state variables assigned or assignable to the particular component, to be at least partially raw data from sensors or data derived therefrom, and preferably for at least some of the sensors to be arranged on the particular component(s), and/or for the received data to originate at least partially from a PLC system.

Preferably, the data used for training the ML model (i.e., during the training method) and the data used for calculating the trained ML model (i.e., when later detecting the operating state) originate at least partially from identical or similar sensors or are based on at least partially identical or similar sensor data.

The object is achieved by the invention according to a third aspect in that a data processing device is proposed having means, i.e. a processor, memory, etc. that are designed to carry out a computer-implemented method according to the first aspect of the invention and/or according to the second aspect of the invention.

All advantages explained in relation to the computer-implemented method according to the first and/or second aspect of the invention apply accordingly to the data processing device according to the third aspect of the invention. Therefore, reference can be made to the previous statements at this point.

The data processing device can, for example, comprise components for receiving the data received in each of the computer-implemented methods. The data processing device can also comprise a memory for storing the received data and/or the ML model at least temporarily.

The object is achieved by the invention according to a fourth aspect in that a data structure is proposed in which component objects and assignments are stored, wherein the component objects can be placed in relation to one another and displayed in the form of a tree structure by means of the assignments, wherein the component objects describe device components and a tree structure of the associated component objects can be displayed for the components of at least two devices, wherein at least two of the at least two tree structures have at least one component object identically.

The proposed data structure makes it particularly easy to manage the components of several devices, especially within a data processing system, and to represent the components that are similar or identical across all devices using a single object. This also allows the data on state variables and/or events of the respective similar or identical components to be efficiently assigned to the single component object. As a result, subsequent training of an ML model intended for similar components on such data can be carried out particularly effectively and simply, in particular with a computer-implemented method according to the fifth aspect of the invention, which is described in more detail below.

For example, if several devices (such as dosing devices) use a similar or identical component X (such as a discharge element), only a single object needs to be provided for this component in the data structure. Based on the assignments, component X (or the associated component object) can then be placed in relation to the other components of the respective device in the tree structure of each of the several devices that comprise this component X (which in turn makes it possible to form the tree structure). The data that arise in connection with the individual components in the individual devices with regard to state variables and/or events can then be assigned to the respective (single) component object as state variable and/or event objects. This simplifies subsequent training in a particularly advantageous manner, since the data structure contains all or at least much of the information for training.

The data structure can be used for training an ML model in a particularly advantageous manner because the data (of the objects) within the data structure represent data that can fulfill a control function in a data processing device during training of a data model. In this respect, the object data of the data structure preferably represent “instructions” that at least partially specify to a computer device used for training how the ML model is designed in the trained state. The object data thus represent “instructions” for a transformation process from an untrained ML model to a trained ML model.

The data structure can advantageously be implementable and/or storable in a database.

The data structure can advantageously be stored or storable on a data carrier and/or transmittable as a signal sequence via a data line. This allows the data structure to be easily deployed at different locations.

Alternatively or additionally, it can also be provided for state variable objects to be stored in the data structure each with at least one assignment to at least one component object.

This makes it particularly easy, for example, to make the associated state variables available for each component in the tree structure, and in particular to retrieve them. Several similar state variable objects can be provided, which are assigned to different device components.

In one embodiment, assignments of several, in particular more than two, state variable objects to at least one component object are stored in the data structure of this component object.

Advantageously, a state variable object includes data that describe the respective state variable or make it determinable. The data can comprise features individually and in any combination that were described in the computer-implemented method according to the first aspect of the invention in relation to state variable data.

Alternatively or additionally, it can also be provided for event objects to be stored in the data structure each with assignments to at least one component object and to at least one state variable object.

This makes it particularly easy, for example, to make the associated events and the associated state variables available for each component in the tree structure, and in particular to retrieve them. Several event objects can be provided, which are assigned to similar device components.

A reference to an event time and/or event period in the respective state variable object can be stored in the data structure for each event object. This allows the event to be directly linked to a concrete course of the state variable. This allows events to be linked to anomalies in the course of the state variable. The event object and the state variable object are advantageously assigned to the same device component (and to the corresponding component object by means of appropriate assignments).

Assignments of several, in particular more than two, event objects to at least one component object can be stored in the data structure of this component object and the associated state variable objects.

Advantageously, an event object includes data that describe the respective event or make it determinable. The data can comprise features individually and in any combination that were described in the computer-implemented method according to the first aspect of the invention in relation to event data.

The object is achieved by the invention according to a fifth aspect in that a computer-implemented method is proposed for training an ML model which serves to detect operating states, in particular error states, in relation to a particular device component, wherein during training of the ML model the state variable objects and event objects assigned to a component object stored in the data structure according to the fourth aspect of the invention, which component object describes the particular device component, are used as training data, in particular as input data and truth data.

The data organized in the data structure can therefore be used particularly easily for training.

The computer-implemented method can optionally also comprise providing the data structure. This can, for example, include receiving the data structure via a data line and/or retrieving the data structure from a memory.

Furthermore, the features of the computer-implemented method according to the first aspect of the invention can advantageously also be provided individually and in any combination in the computer-implemented method according to the fifth aspect of the invention. This applies in particular to features that describe the origin of the object data and/or the relationship between the object data.

The object is achieved by the invention according to a sixth aspect in that a use of a data structure according to the fourth aspect of the invention for training an ML model is proposed.

For the reasons already mentioned above, the data structure is particularly well-suited to be used for training an ML model. Training can then be carried out, for example, using a computer-implemented method according to the first and/or fifth aspect of the invention.

In this respect, all advantages explained in relation to the data structure according to the fourth aspect of the invention also apply accordingly to the use according to the sixth aspect of the invention. Therefore, reference can be made to the previous statements at this point.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic, highly simplified representation of a production environment for cement production;

FIG. 2 shows a flowchart of a computer-implemented method according to the first aspect of the invention;

FIG. 3 shows a flowchart of a computer-implemented method according to the second aspect of the invention;

FIG. 4 shows a data processing device according to the third aspect of the invention; and

FIG. 5 shows a data structure according to the fourth aspect of the invention.

### DETAILED DESCRIPTION

The invention can be explained particularly clearly using the example of cement production.

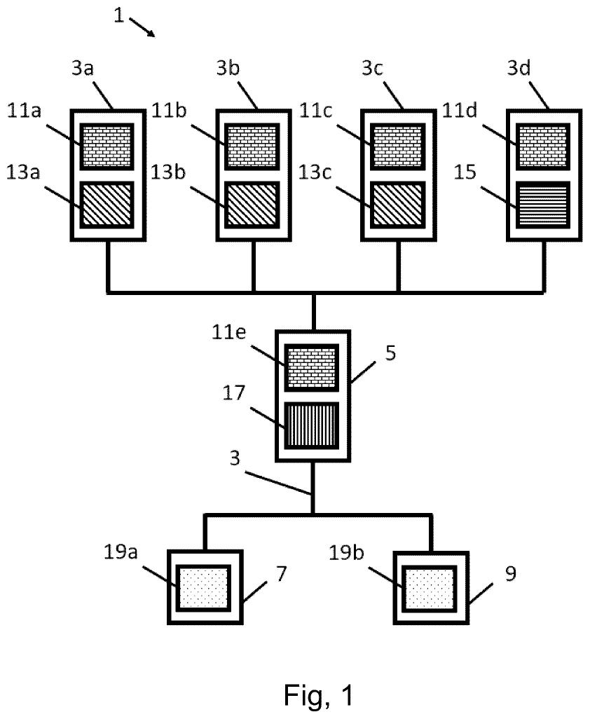

In this context, FIG. 1 shows a schematic, highly simplified representation of a production environment 1 for cement production.

The individual raw materials required for cement production, such as gypsum, additives, granulated blast furnace slag and fly ash, are provided by dosing devices 3a, 3b, 3c and 3d. The dosing device 3a, 3b and 3c can, for example, each be realized by a weigh feeder, while the dosing device 3d is designed as a loss-in-weight feeder.

The raw materials dosed with the individual dosing devices 3a-3d according to a predeterminable recipe are mixed with a mixing device 5, if applicable after further intermediate steps and the addition of further raw materials. After mixing, the finished cement product is weighed by means of a weighing device 7 in the form of a road vehicle scale or a weighing device 9 in the form of a rail scale, depending on whether it is transported by road or rail.

Connecting lines are drawn in FIG. 1 between the individual devices 3a-3d, 5, 7 and 9 to illustrate the described process flow.

Each of the dosing devices 3a-3d has an identical drive system 11a-11d (sometimes also referred to as a gearbox). In the case of weigh feeders 3a, 3b and 3c, the drive system 11a-11c can be used to operate a conveyor belt 13a, 13b and 13c of the respective weigh feeder 3a, 3b and 3c. In the case of the loss-in-weight feeder 3d, a discharge element 15, such as a screw conveyor, can be operated with the drive system 11d.

The mixing device 5 also has a drive system 11e that is identical to drive systems 11a-11d. The drive system 11e can be used to operate an agitator 17 of the mixing device 5 for mixing the individual raw materials. Ultimately, both the road scale 7 and the track scale 9 each have a weighing unit 19a and 19b. The weighing units 19a and 19b can advantageously be designed as weighing beams.

The devices 3a-3d, 5, 7 and 9 of the production environment 1 have numerous components, of which, for the sake of clarity, only some have been described with components 11a-11e, 13a-13c, 15, 17, 19a and 19b and illustrated in FIG. 1.

During operation of the devices 3a-3d, 5, 7 and 9, the operating states of the individual components 11a-11e, 13a-13c, 15, 17, 19a and 19b are supposed to be continuously monitored. This allows, for example, a quick response to an error related to one of the components, and remedial measures can be initiated. This can avoid or at least reduce downtime. Monitoring a state of wear of the components, especially in case of mechanical components, such as a discharge element, can also be achieved in this way.

To do this, machine-related data are first processed in such a way that a separate database is created for each group of components and a separate machine-learning (ML) model is trained thereon.

The machine-related data originate, on the one hand, from sensors assigned to the individual components 11a-11e, 13a-13c, 15, 17, 19a and 19b, and represent the information on state variables of the respective components 11a-11e, 13a-13c, 15, 17, 19a and 19b. The following table shows the selected state variables and the sensors used as data sources for the individual components 11a-11e, 13a-13c, 15, 17, 19a and 19b.

| Device | Component | State variable | Sensor |
|---|---|---|---|
| Dosing device 3a | Drive system 11a | Direction of movement | Vibration sensor |
| | Conveyor belt 13a | Support roller speed | Speed sensor |
| Dosing device 3b | Drive system 11b | Direction of movement | Vibration sensor |
| | Conveyor belt 13b | Support roller speed | Speed sensor |
| Dosing device 3c | Drive system 11c | Direction of movement | Vibration sensor |
| | Conveyor belt 13c | Support roller speed | Speed sensor |
| Dosing device 3d | Drive system 11d | Direction of movement | Vibration sensor |
| | Discharge element 15 | Torque | Torque sensor |
| Mixing device 5 | Drive system 11e | Direction of movement | Vibration sensor |
| | Agitator 17 | Torque | Torque sensor |
| Weighing device 7 | Weighing unit 19a | Current | Current sensor |
| Weighing device 9 | Weighing unit 19b | Current | Current sensor |

Accordingly, for example, a speed sensor is provided for each conveyor belt 13a-13c, which continuously provides a current speed of a support roller of the conveyor belt as a measured value. Said measured value can be received and further processed.

The individual components 11a-11e, 13a-13c, 15, 17, 19a and 19b can be grouped into the mentioned component groups. In the present case, for example, components 11a-11e can be assigned to a “drive system” component group, components 13a-13c to a “conveyor belt” component group, component 15 to a “discharge element” component group, component 17 to an “agitator” component group and components 19a and 19b to a “weighing unit” component group. In FIG. 1, for faster orientation, the rectangles of the components assigned to a common component group are filled with the same pattern.

If, during operation of the devices 3a-3d, 5, 7 and 9, certain states occur in the individual components (in particular good states and error states), said states can be logged as events, for example together with a time stamp of their occurrence. These events constitute additional machine-related data that are processed.

For each component of a component group, the time-indexed sensor data associated with these components and the logged events form the above-mentioned database. For example, the database for the “drive system” component group is formed by the data of the vibration sensors assigned to the drive systems 11a-11e and the events logged for the drive systems 11a-11e over a defined period of time (for example, the past seven days).

An individual ML model can then be trained on the database of each component group. The sensor data of the database are used as input data and the event data of the database are used as truth data. An ML model trained in this way can detect operating states of components of the respective component group for which it was trained. For this purpose, the trained ML model is calculated on input data in the form of current (sensor) data on state variables (for example, the direction of movement in case of a component of the “drive system” component group) that correspond to the state variables considered during training.

It should be noted in particular that the trained ML model can also detect operating states of components for which no data was considered in the training database, as long as the component can be assigned to the respective component group for which the ML model was trained. This is what makes the proposed training of an ML model with a computer-implemented method according to the first aspect of the invention, which is summarized again below using an example, so advantageous.

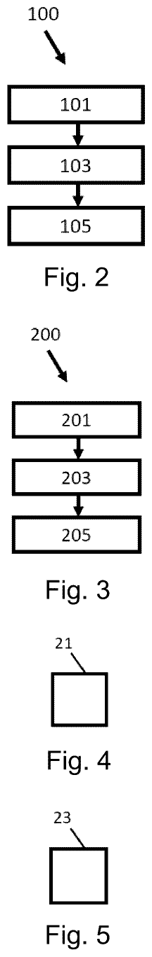

In this context, FIG. 2 shows a flowchart 100 of a computer-implemented method according to the first aspect of the invention.

In 101, the above-described components 11a-11e, 13a-13c, 15, 17, 19a and 19b of the devices 3a-3d, 5, 7 and 9 of the production environment 1 are selected as specific components and assigned to the “drive system”, “conveyor belt”, “discharge element”, “agitator” and “weighing unit” component groups.

In 103, the sensor data on the direction of movement (through a time series with information on the direction and absolute acceleration value at different times) of the drive systems 11a-11e and the logged events for the drive systems 11a-11e are received for the components 11a-11e of the first component group called “drive system.” For example, the data come from an observation period of the past 7 days.

In 105, an ML model is trained on the database formed by the sensor data and event data. Here, the sensor data form the input data of the ML model and the event data constitute truth data.

In 103 and 105, data are received in parallel with the other component groups (“conveyor belt”, “discharge element”, “agitator” and “weighing unit”) and an ML model is trained on a database formed from the respective data. This means that a trained ML model is then available for each component group.

During operation of the devices 3a-3d, 5, 7 and 9, operating states of the individual components of the devices can be detected using the trained ML models in a computer-implemented method according to the second aspect of the invention.

In this context, FIG. 3 shows a flowchart 200 of a computer-implemented method according to the second aspect of the invention.

For example, the operating state of the drive system 11a of the dosing device 3a is supposed to be monitored and detected.

For this purpose, current sensor data on the direction of movement of the drive system 11a are received in 201. Such data can be the data of the vibration sensor, which is arranged on the drive system 11a for this purpose.

In 203, the ML model trained as described with reference to FIG. 2 is calculated on the received data as input data.

In 205, event data on the current operating state of the drive system 11a are obtained as a result of the calculation of the ML model. Said event data can indicate a good or bad state of component 11a.

Similarly, operating states of the remaining components 11b-11e, 13a-13c, 15, 17, 19a and 19b can also be detected using the previously trained ML models and the respective current sensor data as input data.

FIG. 4 shows a data processing device 21 according to the third aspect of the invention. The device comprises means designed to carry out a computer-implemented method according to the first and/or second aspect of the invention.

FIG. 5 shows a data structure 23 according to the fourth aspect of the invention.

In the data structure, information on the components can be stored in component objects, information on state variables in state variable objects and information on events in event objects. Here, only a single component object must be provided for similar or identical components of several devices (such as for drive systems 11a-11e of devices 3a-3d and 5), to which the information on state variables and events is assigned by means of assignments.

With such an organized data structure, training for each component group can be carried out particularly easily, since each component group is represented by a single component object and all necessary training data in the data structure can be accessed via the assignments.

Finally, it should be pointed out once again that the representation in FIG. 1 only shows excerpts of the stages of cement production and that the devices shown therein are only very simplified representations.

The following examples illustrate advantageous embodiments of the individual aspects of the invention.

Example 1. Computer-implemented method for processing machine-related data in order to obtain at least one trained machine-learning (ML) model, the computer-implemented method comprising:
that components of at least two devices are selected as specific components and are each assigned to at least one of at least one definitional component group,
that data are received which, in relation to each of the specific components, represent and/or make it possible to determine information on (i) one or more of the state variables assigned or assignable to the respective specific component and (ii) one or more events relating to the respective specific component; and that for each of the at least one component groups, a separate ML model is trained on a separate database, each of which is at least partially created on the basis of at least parts of the received data.

Example 2. Computer-implemented method according to Example 1, wherein for each device of at least two devices, at least one component of the respective device is selected as a specific component and is assigned to at least one and/or exactly one component group of at least one definitional component group in such a way that after the assignment of all specific components of all devices (i) the specific components assigned to one and the same component group are all similar or identical and/or (ii) the specific components which are all similar or identical among all specific components of all devices are each assigned to the same component group.

Example 3. Computer-implemented method according to any of the preceding examples, wherein at least two, preferably all, of the at least two devices are of a different type and/or wherein at least two of the at least two devices are selected differently from the group of devices comprising: dosing device, screening device, vibration device, mill, extruder, conveying device, weighing device, mixing device and/or test bench.

Example 4. Computer-implemented method according to any of the preceding examples, wherein each selected specific component is assigned to at least one and/or exactly one component group of at least two definitional component groups.

Example 5. Computer-implemented method according to any of the preceding examples, wherein at least one component group is selected from the group of component groups comprising: wheel, axle, bogie, carriage, gearbox, bearing (machine element), guide element, motor, discharge element, drive system, conveyor belt, agitator, weighing unit and/or unbalance drive.

Example 6. Computer-implemented method according to any of the preceding examples, wherein two or more than two specific components are selected for each device of the at least two devices and/or the respectively selected specific components are assigned to different component groups for each device of the at least two devices.

Example 7. Computer-implemented method according to any of the preceding examples, wherein the specific components are mechanical components, electrical components and/or components of the devices that are subject to wear.

Example 8. Computer-implemented method according to any of the preceding examples, wherein the received data represent or make it possible to determine information on state variables and/or events, in particular error events and/or good events, in relation to the specific components, wherein the received data preferably include individual information for at least one and/or each specific component.

Example 9. Computer-implemented method according to any of the preceding examples, wherein the respective database for training the respective ML model of a component group contains, in particular explicitly and/or implicitly, at least the information on state variables and/or events in relation to the specific components assigned to the respective component group.

Example 10. Computer-implemented method according to any of the preceding examples, wherein the information on each state variable in each case (i) is represented by time series data, (ii) has a time-dependent course (iii) is represented or determinable by at least part of the received data and/or (iv) is obtained by processing at least part of the received data, and/or wherein (i) each state variable is assigned to exactly one and/or at least one specific component, (ii) several specific components are assigned corresponding state variables and/or (iii) the same state variables are assigned to each specific component within a component group.

Example 11. Computer-implemented method according to any of the preceding examples, wherein each event of a specific component is an assignment of a good or bad marking to an event time or an event period in relation to the course of one or more state variables, assigned in particular to the respective specific component, in particular by assigning a state category to the respective time or period.

Example 12. Computer-implemented method for detecting an operating state, in particular an error state, in a particular component of a device, the computer-implemented method comprising: that data representing and/or making it possible to determine information on one or more state variables assigned or assignable to the particular component are received; and that a trained ML model is calculated with the received data as input data, such that the output data of the trained ML model represents the operating state of the device.

Example 13. A data processing device having components that are designed to carry out a computer-implemented method according to any of Examples 1 to 11 and/or 12.

Example 14. Data structure in which component objects and assignments are stored, wherein the component objects can be placed in relation to one another and displayed in the form of a tree structure via the assignments, wherein the component objects describe device components and a tree structure of the associated component objects can be displayed for the components of at least two devices, wherein at least two of the at least two tree structures have at least one component object identically.

Example 15. Data structure according to Example 14, wherein state variable objects are stored in the data structure, each with at least one assignment to at least one component object, and/or wherein event objects are stored in the data structure, each with assignments to at least one component object and to at least one state variable object.

The features disclosed in the description above, in the drawings and in the claims can be essential to the invention in its various embodiments, both individually and in any combination.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for detecting an operating state in a particular component of a device, the computer-implemented method comprising:
receiving data that represent and/or makes it possible to determine information on one or more state variables assigned or assignable to the particular component; and
calculating a trained machine-learning model at least partially with the received data as input data, the trained ML model being obtained as a training method during a computer-implemented method preceding the detection for processing machine-related data in order to obtain at least one trained ML model, the training method comprising:
selecting components of at least two devices as specific components and are each assigned to at least one of at least one definitional component group and/or (ii) for each device of at least two devices, at least one component of the respective device is selected as a specific component and is assigned to at least one and/or exactly one component group of at least one definitional component group in such a way that after the assignment of all specific components of all devices (a) the specific components assigned to one and the same component group are all similar or identical and/or (b) the specific components which are all similar or identical among all specific components of all devices are each assigned to the same component group;
receiving data, which, in relation to each of the specific components, represent and/or make it possible to determine information on (i) one or more of the state variables assigned or assignable to the respective specific component and (ii) one or more events relating to the respective specific component; and
training, for each of the at least one component groups, a separate ML model on a separate database, each of which is at least partially created on the basis of at least parts of the received data.

2. The computer-implemented method according to claim 1, wherein the particular component is assignable to the component group for which the ML model was trained in the preceding computer-implemented method and/or the database used in the preceding training of the ML model was created at least partially with data which represent and/or make it possible to determine information on state variables that correspond to the one or more state variables assigned or assignable to the particular component.

3. The computer-implemented method according to claim 1, wherein, for calculating the trained ML model, the ML model of the ML models trained within the scope of the training method is used which was trained on data from specific components which are assigned or assignable to specific components of the component group to which the specific component is also assigned or assignable.

4. The computer-implemented method according to claim 1, wherein an operating state of the particular component is detected at least partially based on a result of the calculation of the trained ML model and/or wherein a control signal is generated in response to the detection of the operating state of the particular component and/or as a function of the detected operating state of the particular component.

5. The computer-implemented method according to claim 4, wherein the particular component and/or the device comprising the particular component is influenced by the control signal, wherein such influencing preferably comprises adapting a configuration of the component and/or device, adapting an energy consumption of the component and/or device and/or switching off the particular component and/or device.

6. The computer-implemented method according to claim 1, wherein the received data, which represent and/or make it possible to determine information on one or more state variables assigned or assignable to the particular component, are at least partially raw data from sensors or data derived therefrom, and preferably at least some of the sensors are arranged on the particular component(s), and/or the received data originate at least partially from a PLC system.

7. The computer-implemented method according to claim 1, wherein the training method comprises that for each device of at least two devices, at least one component of the respective device is selected as a specific component and is assigned to at least one and/or exactly one component group of at least one definitional component group in such a way that after the assignment of all specific components of all devices (i) the specific components assigned to one and the same component group are all similar or identical and/or (ii) the specific components which are all similar or identical among all specific components of all devices are each assigned to the same component group.

8. The computer-implemented method according to claim 1, wherein the training method comprises that at least two, preferably all, of the at least two devices are of a different type, and/or wherein the training method comprises that at least two of the at least two devices are selected differently from the group of devices comprising: dosing device, screening device, vibration device, mill, extruder, conveying device, weighing device, mixing device and/or test bench.

9. The computer-implemented method according to claim 1, wherein the training method comprises that each selected specific component is assigned to at least one and/or exactly one component group of at least two definitional component groups.

10. The computer-implemented method according to claim 1, wherein the training method comprises that at least one component group is selected from the group of component groups comprising: wheel, axle, bogie, carriage, gearbox, bearing (machine element), guide element, motor, discharge element, drive system, conveyor belt, agitator, weighing unit and/or unbalance drive.

11. The computer-implemented method according to claim 1, wherein the training method comprises that two or more than two specific components are selected for each device of the at least two devices and/or the respectively selected specific components are assigned to different component groups for each device of the at least two devices.

12. The computer-implemented method according to claim 1, wherein the training method comprises that the specific components are mechanical components, electrical components and/or components of the devices that are subject to wear.

13. The computer-implemented method according to claim 1, wherein the training method comprises that the received data represent or make it possible to determine information on state variables and/or events, in particular error events and/or good events, in relation to the specific components, wherein the received data preferably include individual information for at least one and/or each specific component.

14. The computer-implemented method according to claim 1, wherein the training method comprises that the received data are at least partially raw data from sensors or data derived therefrom and preferably at least some of the sensors are arranged on the specific components and/or the received data originate at least partially from a PLC system.

15. The computer-implemented method according to claim 1, wherein the training method comprises that the respective database for training the respective ML model of a component group contains, in particular explicitly and/or implicitly, at least the information on state variables and/or events in relation to the specific components assigned to the respective component group.

16. The computer-implemented method according to claim 1, wherein the training method comprises that the information on each state variable (i) is each represented by time series data, (ii) each has a time-dependent course (iii) is represented or determinable by at least part of the received data and/or (iv) is obtained by processing at least part of the received data, and/or wherein the training method comprises that (i) each state variable is assigned to exactly one and/or at least one specific component, (ii) several specific components are assigned corresponding state variables and/or (iii) the same state variables are assigned to each specific component within a component group.

17. The computer-implemented method according to claim 1, wherein the training method comprises that the state variables of at least one and/or all specific components are selected, in particular manually and/or with a feature selection algorithm, from a selection of state variables, wherein selection of the state variables for the specific components of a component group is preferably carried out jointly.

18. The computer-implemented method according to claim 1, wherein the training method comprises that each event of a specific component is an assignment of a good or bad marking to an event time or an event period in relation to the course of one or more state variables, assigned in particular to the respective specific component, in particular by assigning a state category to the respective time or period.

19. The computer-implemented method according to claim 1, wherein the training method comprises that the processing of the machine-related data is carried out in order to obtain at least one trained ML model and/or at least one trained ML model is obtained as a result of the processing of the data, in particular at least such ML model which is calculated to detect the operating state in the particular component.

20. A computer-implemented method for processing machine-related data, which represent information on state variables and events associated with or assignable to device components or used to determine the same in order to obtain at least one trained machine-learning model, the computer-implemented method comprising:
selecting components of at least two devices as specific components and are each assigned to at least one of at least one definitional component group and/or (ii) for each device of at least two devices, at least one component of the respective device is selected as a specific component and is assigned to at least one and/or exactly one component group of at least one definitional component group in such a way that after the assignment of all specific components of all devices (a) the specific components assigned to one and the same component group are all similar or identical and/or (b) the specific components which are all similar or identical among all specific components of all devices are each assigned to the same component group;
receiving data, which, in relation to each of the specific components, represent and/or make it possible to determine information on (i) one or more of the state variables assigned or assignable to the respective specific component and (ii) one or more events relating to the respective specific component; and
training, for each of the at least one component groups, a separate ML model on a separate database, each of which is at least partially created on the basis of at least parts of the received data.

21. A computer-implemented method for processing machine-related data in order to obtain at least one trained machine-learning model, the computer-implemented method comprising:
selecting components of at least two devices as specific components and are each assigned to at least one of at least one definitional component group;
receiving data, which, in relation to each of the specific components, represent and/or make it possible to determine information on (i) one or more of the state variables assigned or assignable to the respective specific component and (ii) one or more events relating to the respective specific component; and
training, for each of the at least one component groups, a separate ML model on a separate database, each of which is at least partially created on the basis of at least parts of the received data.

22. A computer-implemented method for detecting an operating state, in particular an error state, in a particular component of a device, the computer-implemented method comprising:
receiving data representing and/or making it possible to determine information on one or more state variables assigned or assignable to the particular component; and
calculating a trained ML model with the received data as input data, such that the output data of the trained ML model represents the operating state of the device.

23. A data structure in which component objects and assignments are stored, wherein the component objects are placed in relation to one another and displayed in the form of a tree structure via the assignments, wherein the component objects describe device components and a tree structure of the associated component objects are displayed for the components of at least two devices, wherein at least two of the at least two tree structures have at least one component object identically.

24. The data structure according to claim 23, wherein state variable objects are stored in the data structure, each with at least one assignment to at least one component object, and/or wherein event objects are stored in the data structure, each with assignments to at least one component object and to at least one state variable object.
